(19) United States
(12) Patent Application Publication
(10) Pub. No.: US 2002/0153329 A1
(43) Pub. Date: Oct. 24, 2002

(54) Process for the conditioning of polluted water

(75) Inventors: Dietmar Hempel, Wolfenbuettel (DE); Rainer Krull, Braunschweig (DE); Thomas Jung, Kropp (DE); Andrea Preuss, Hanau (DE); Henning Raschke, Frankfurt (DE); Gerhard Sepp, Kleinostheim (DE); Matthias Woyciechowski, Langenselbold (DE)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: Degussa AG, Duesseldorf (DE)

(21) Appl. No.: 10/103,771

(22) Filed: Mar. 25, 2002

(30) Foreign Application Priority Data
Mar. 23, 2001 (DE) 101 14 177.7

(51) Int. Cl. C02F 1/72

(52) U.S. Cl. 210/759; 210/763; 210/760

(57) ABSTRACT

The invention relates to a process for the treating or conditioning of polluted water using a source of hydrogen peroxide and/or ozone and a heterogeneous catalyst.

### BACKGROUND OF INVENTION

1. Field of the Invention

The invention relates to a process for the treating or conditioning of water and comprises contacting water with a source of hydrogen peroxide, ozone, or mixtures thereof in the presence of a heterogeneous catalyst.

2. Discussion of the Background

A wide variety of processes and are used to purify water, especially effluent. Examples of such processes include chemical-physical processes and adsorptive processes. Chemical-physical processes include precipitation and flocculation. Adsorptive processes include those using activated carbon. Finally pollutants may be removed by biodegradation or oxidation of the pollutants directly.

Recently, technologies in which pollutants are oxidized have been adopted for the treatment of effluent. Such technologies include oxidation of pollutants using highly reactive hydroxyl radicals which may be produced by various means. These technologies can be photolytic in nature. Examples include UV-induced, oxidation, oxidation with hydrogen peroxide in the presence of an iron catalyst (Fenton's reagent), the combinations H₂O₂/UV and Ozone/UV. These effluent treatments are carried out in the homogeneous phase. However, treatments of water are also known where oxidation with hydrogen peroxide occurs in the presence of a heterogeneous catalyst.

Using hydrogen peroxide by itself as a treatment can not satisfactorily eliminate pollutants from water. Hydrogen peroxide can be activated by UV light to produce hydroxyl radicals having high oxidation potential. However, one disadvantage of the radiation-induced activation of hydrogen peroxide is that the radiation does not penetrate far enough into most of the effluents to be treated. Therefore, this method bears a burden of high technical costs in order to adequately eliminate pollutants from water.

The treatment of water using hydrogen peroxide and dissolved iron(II) salts, i.e. Fenton's reagent, has already been described in detail. O. Specht, I. Wurdack and D. Wagner, for example, disclose in Chemie Ingenieur Technik 9/95, pages 1089-1090, a multi-stage pilot plant for the oxidative treatment of water by the Fenton process. The technology of the process is very costly because the plant has both a reactor cascade, a reactor to neutralize the strongly acid-treated water and a combination of a sedimentation tank and a chamber filter press for separation of the iron hydroxide deposit formed as a byproduct of the reaction.

Serious disadvantages of the use of Fenton's reagent for the treatment of effluent are also highlighted in the conference paper of I. Wurdack, C. Höfl, G. Sigl, O. Specht, D. Wabner “Oxidative Degradation of AOX and COD in Real Effluents: a Comparison of Various Advanced Oxidation Processes”, 3rd GVC Conference (Oct. 14-16, 1996, Würzburg) “Processing Methods for the Treatment of Effluent and Sludge”, Report 9713/131, published by VDI 1996. According to this paper, the reaction works only at very acidic pH values, namely pH of from 2 to 3. Therefore, the water must first be acidified and then re-neutralized after oxidation with Fenton's reagent before it can be released into a purification plant or a body of receiving water. A disadvantage is that this results in considerable salinization of the treated water and considerable quantities of a sparingly soluble iron hydroxide deposit are also produced, which must be separated off. A further disadvantage is the use of very large quantities of hydrogen peroxide because this reaction entails high non-specific consumption of hydrogen peroxide.

EP 0 257 983 A2 discloses an oxidative treatment of water with an oxygenic gas in the presence of a heterogeneous catalyst. The catalyst in this case being a combination of a mixed oxide catalyst of at least two elements from the series titanium, silicon and zirconium, and one further catalyst component, which may include manganese, iron, cobalt, nickel, tungsten, copper, silver and precious metals. The disadvantage of this process is that the effluent must be treated at a temperature ranging from 100 to 370° C., in particular 200 to 300° C. At such high temperatures, the biodegradability of partially-oxidized pollutants is reduced. Although ozone or hydrogen peroxide can be used in addition to the oxygenic gas, this document does not suggest carrying out the treatment at a considerably lower temperature.

DE OS 19 925 534 describes a process in which some of the disadvantages associated with the above-mentioned process and the process of treating polluted effluent with Fenton's reagent can be avoided. DE OS 19 925 534 describes using a titanium-containing silicate, in particular a titanium silicate, as a heterogeneous catalyst for the formation of hydroxyl radicals from hydrogen peroxide. When using such a heterogeneous catalyst, partial oxidation of the pollutants in water is achieved at room temperature or moderately raised temperature, thus improving the biodegradability of the pollutants. One disadvantage of this process is that the activity is lower than that of the iron(II) salts in Fenton's reagent, so that an adequate degree of pollutant elimination in the water is achieved only in certain cases. A further disadvantage of the titanium-containing silicates is that they are available initially in powder form and so precautions must be taken for their retention. Although these catalysts can be converted into mouldings, this results in a loss of activity, which restricts their use for the oxidation of constituents with hydrogen peroxide in water.

Jörg Hoffmann et al. disclose a process similar to that mentioned above in Chemie Ingenieur Technik (71) 4/99, 399 - 401. However, they use a Ni- and Cu-containing metal catalyst in knitted form. In addition to hydrogen peroxide, sodium percarbonate and peracetic acid are also mentioned as oxidizing agents. The water is treated at pH ranging from 6 to 7. Unfortunately, a satisfactory discharge rate is achieved only at elevated temperature.

### SUMMARY OF THE INVENTION

One object of the present invention is a process for the treatment of water.

Another object of the present invention is a process for the treatment of water that is simple and cost-efficient.

Another object of the present invention is a process for the treatment of water that requires low temperatures.

Another object of the present invention is a process for the treatment of water that requires close to neutral pH.

Another object of the present invention is a process for the treatment of water comprising contacting water with a source of hydrogen peroxide and/or ozone in the presence of a heterogeneous catalyst containing Fe(III)—OH structural elements.

Another object of the present invention is a process for the treatment of water comprising feeding water over a fixed bed reactor filled with a catalyst by means of a bubble or trickle bed method and adding hydrogen peroxide or a source thereof continuously or periodically to the untreated or partially treated water.

Another object of the present invention is a process for the treatment of water comprising feeding water over a fixed bed reactor filled with a catalyst by means of a bubble or trickle bed method and fumigating the water, the reactor, or both with ozone.

Another object of the present invention is a process for the treatment of water comprising feeding water over a fixed bed reactor filled with a catalyst by means of a bubble or trickle bed method, adding hydrogen peroxide or a source thereof continuously or periodically to the untreated or partially treated water, and fumigating the water, the reactor, or both with ozone.

### BRIEF DESCRIPTION OF THE DRAWINGS

FIG. 1: A plot of the rate of complete oxidation of COD as a function of pH.

FIG. 2: Plots of the COD discharged, the COD load, and the Fe eluted as a function of bed volume changes.

FIG. 3: Plots of the amount of DOC as a function of the amount of ozone consumed for various cycles with and without catalyst according to the present invention.

### DETAILED DESCRIPTION OF THE PRESENT INVENTION

In view of the above, a need exists to find a process for treating water that is simple and cost-efficient, resulting in the rapid degradation of pollutants therein. One example of water that can be treated according to the present invention is effluent.

The process of the present invention is a treatment of water with a source of hydrogen peroxide and/or ozone in the presence of a heterogeneous catalyst containing Fe(III)—OH. A heterogeneous catalyst containing FE(III)—OH structural elements means that the catalyst contains one or more groups of the formula Fe^{III}—OH. The catalyst can be a material containing less or more water than the composition according to the formula Fe(O)OH, as long as Fe(III)—OH structural elements are present.

The catalyst can be iron(III)-hydroxide of the formula Fe(OH)₃ or an oxide hydrate formed by partial dehydration. The iron(III)-oxide hydrate preferred by the present invention can be produced from neutralization precipitation of an iron(III) salt, followed by dehydration. By dehydration of iron(III) oxide of the formula Fe(OH)₃, which is one preferred catalyst, many intermediate compounds may be formed step-wise, e.g. (HO)₂Fe—O—Fe(OH)₂ and (HO)₂Fe—OFe(OH)—O—Fe—(OH)₂ up to the most favored mixed hydrate of the general formula Fe(O)OH (which is not a monomer but an oligomer/polymer network). Further dehydration is possible as long as the catalyst still contains Fe—OH—groups in a catalytically effective quantity. Dehydration is preferably carried out under conditions which the iron oxide hydrate is present in a beta modification.

According to a preferred embodiment the catalyst having Fe(III)—OH structural elements, i.e. in particular iron(III)-hydroxide and iron(III)-oxide hydrate or a combination of these substances, can be but is not limited to being in the form of mouldings. Mouldings are those bodies that are suitable for use in a fixed bed column, for example granulates or extrudates. Mouldings may contain, in addition to the material containing the Fe(III)—OH structural elements, binders and/or other catalytically active components. Examples of binders for the moulded catalysts are silica sol, precipitated or pyrogenic silica, aluminum oxide or silicates. The mass content of the binder is not limited and is generally in the range of from 5 to 30 wt. % in relation to the mouldings. The ranges for the mass content of the binder include all specific values and subranges therebetween, such as 10, 15, 20, and 25 wt. % in relation to the mouldings. All processes known per se can be used for production of moulding. However, if the moulding process involves a calcining step, it must be ensured that iron(III)—OH structural elements and, in particular, beta-Fe(O)OH remains in the catalyst in order to ensure sufficient activity.

The catalyst according to the invention can be used alone, or in combination with other catalytically active heterogeneous catalysts. Examples of active heterogeneous catalysts are those disclosed in DE OS 19 925 534 and are herein incorporated by reference. However, when treating water using the catalyst of the present invention, a significantly higher degree of pollutant degradation is achieved than when using the previously known heterogeneous catalyst based on a titantium-containing silicate.

In a particular embodiment of the present invention, a synthetic, granulated iron hydroxide is used as the catalyst, which normally serves as an adsorbent for the adsorption of arsenic from drinking water (see J. Water SRT-Aqua Vol. 47, No. 1, pages 30-35 (1998)).

Water of various origins can be treated by the process according to the present invention. In particular, effluent, circulating, and process water can be treated, especially those which contain constituents that are oxidizable organic or inorganic compounds. The process according to the invention is particularly advantageous if the constituents in the water are not easily biodegradable. The present invention can treat effluent from municipalities, as well as from chemical and pharmaceutical industries. These waters can contain chlorinated hydrocarbons and phenols from metal processing and petroleum industries. Examples of other types of water that may be treated according to the present invention include but are not limited to groundwater contaminated with organic substances, deposit seepage water, dyed effluent from the textile and printing industries, effluent from the water lacquer processing industry, hospital effluent, and effluent from waste air cleaners.

Examples of pollutants treatable according to the present invention are various substituted aliphatic, cycloaliphatic and aromatic organic compounds, such as e.g. sulfurous organic substances with mercapto- or sulfo-functions, carboxylic acids, amides, amines, aliphatic hydrocarbons, mono- and polynuclear aromatic or heteroaromatic compounds, halogenated, in particular chlorinated, aliphatic and aromatic compounds, homo- and heterocyclic cycloaliphatics and water-soluble or emulsified polymers and copolymers.

The pollutants in the water to be treated the process according to the invention are oxidized at least partially, but mainly to a very high degree, producing degradation products that can easily be further biodegraded In many cases, not all of the pollutants present in water to be treated are known and/or identifiable. Therefore, summation parameters are used to characterize the polluted water, such as the Chemical Oxygen Demand (COD, determined to DIN ISO 6060 or DIN 38409/41) or Total Organic Carbon (TOC, to EN 1484). The aim of the process according to the invention is therefore to achieve initially a certain reduction in the COD or TOC obtained and also an improvement in biodegradability, as measured in standard tests such as that in DIN EN 29 888 (Zahn-Wellens process). Partial oxidation of pollutant constituents in water treated by the process according to the present invention can also reduce or eliminate the inhibition of nitrification. This can be determined by a standard method described by Degussa SOP UT-001.

The concentration of the constituents in the water to be treated according to the present invention can cover a wide range, for example a range of from 0.1 to 100 g COD per L of water. The ranges for the concentration of the constituents in the water to be treated include all specific values and subranges therebetween, such as 5, 10, 20, 25, 30, 35, 40, 45, 50, 55, 60, 65, 70, 75, 80, 85, 90, and 95 g COD per L of water. The pollutant content is most often, and therefore preferably, in the range 0.1 to 20 g COD per L water.

The process according to the invention is carried out under mild reaction conditions. The pH value of the water is generally higher than 3, which is a value higher than that required for oxidation when using Fenton's reagent. For the process according to the invention, the pH value is preferably in the range 3 to 9, in particular in the range 5 to 9. A pH value in the range of from 6 to 8 is preferred because this largely avoids elution of iron from the heterogeneous catalyst according to the invention, but at least keeps it at a tolerably low level. In order to avoid any significant elution of iron, it is useful, in continuous operation, to control and regulate the pH value and, if the effluent is too acid, to increase the pH value accordingly. The ranges for the pH value includes all specific values and subranges therebetween, such as 3.5, 4, 4.5, 5, 5.5, 6, 6.5, 7, 7.5, 8, and 8.5.

The process according to the invention is carried out at a temperature above the freezing point of the water to be treated. Therefore, the process of the present invention treats water at a temperature preferably in the range 10 to 50° C., in particular 15 to 40° C. The ranges for the temperature includes all specific values and subranges therebetween, such as 10, 15, 20, 25, 30, 35, 40, and 45° C.

A source of hydrogen peroxide is used as the oxidizing agent for the process according to the invention. Suitable sources of hydrogen peroxide are aqueous solutions of hydrogen peroxide, which may have a wide range of H₂O₂ concentrations. Depending on the operating conditions, an H₂O₂ concentration in the range 10 to 70 wt. %, in particular 30 to 50 wt. % is generally used. The ranges for the H₂O₂ concentration includes all specific values and subranges therebetween, such as 10, 15, 20, 25, 30, 35, 40, 45, 50, 55, 60, and 65 wt. %.

Other sources of hydrogen peroxide are per salts such as sodium percarbonate and sodium perborate. Sodium percarbonate being preferred by the present invention because it releases sodium and carbonate ions as well as H₂O₂ when in aqueous solution, which simultaneously increases the pH value of the water to be treated. Another source of hydrogen peroxide is peracetic acid, in particular a so-called equilibrium peracetic acid, which contains hydrogen peroxide as well as peracetic acid. Peracetic acid is a stronger oxidizing agent than hydrogen peroxide alone.

The amount of hydrogen peroxide or another source of hydrogen peroxide to be used is determined by the content of pollutants in the water and their degradibility. The so-called COD value (Chemical Oxygen Demand) is a measure of the level of pollutants in the water. Active oxygen in the form of a source of H₂O₂ in a quantity in the range from 0.1 to 25 g, in particular 0.5 to 5 g, is used per g of COD to be eliminated from water. The ranges for the quantity of active oxygen in the form of a source of H₂O₂ include all specific values and subranges therebetween, such as 0.5, 1, 1.5, 2, 2.5, 3, 3.5, 4, 4.5, 5, 5.5, 6, 6.5, 7, 7.5, 8, 8.5, 9, 9.5, 10, 10.5, 11, 11.5, 12, 12.5, 13, 13.5, 14, 14.5, 15, 15.5, 16, 16.5, 17, 17.5, 18, 18.5, 19, 19.5, 20, 20.5, 21, 21.5, 22, 22.5, 23, 23.5, 24, and 24.5 g per g of COD to be eliminated from water. It was ascertained that, in the process according to the invention, from 0.5 to less than 1.5 g active oxygen per g COD to be eliminated from water is sufficient in many cases. When using Fenton's reagent in these cases, a higher quantity of active oxygen is required.

Hydrogen peroxide, in conjunction with a source of ozone, can also be used in the process according to the invention as an alternative to hydrogen peroxide or another source of hydrogen peroxide. The quantity of ozone used is generally kept lower as it has a higher oxidation potential than H₂O₂. Ozone is O₃ and may be formed in an ozone generator by an electrical gas discharge.

Ozone is a very strong oxidizer. Without being limited by theory, one mole of ozone produces one mole of active oxygen according to the following equation:

O₃→O₂+O_{active}

Also, hydrogen peroxide produces one mole of active oxygen according to the following equation:

H₂O₂→H₂O+O_{active}

Nevertheless, the oxidation power of ozone is usually higher than that of hydrogen peroxide. Therefore, the quantity of ozone used in the water treatment may be lower than that of hydrogen peroxide on a molar basis.

The catalyst according to the invention having an Fe(III)—OH structural element can be used in powder form. In this case, water treatment is carried out in devices suitable for handling suspensions. In this case, a catalyst quantity of 0.05 to 100 g/L, preferably 0.5 to 10 g/L of water to be treated is generally used. The ranges for the catalyst quantity include all specific values and subranges therebetween, such as 0.5, 1, 1.5, 2, 2.5, 3, 3.5, 4, 4.5, 5, 5.5, 6, 6.5, 7, 7.5, 8, 8.5, 9, 9.5, 10, 10.5, 11, 11.5, 12, 12.5, 13, 13.5, 14, 14.5, 15, 15.5, 16, 16.5, 17, 17.5, 18, 18.5, 19, 19.5, 20, 20.5, 21, 21.5, 22, 22.5, 23, 23.5, 24, 24.5, 25, 25.5, 26, 26.5, 27, 27.5, 28, 28.5, 29, 29.5, 30, 30.5, 31, 31.5, 32, 32.5, 33, 33.5, 34, 34.5, 35, 35.5, 36, 36.5, 37, 37.5, 38, 38.5, 39, 39.5; 40, 40.5, 41, 41.5, 42, 42.5, 43, 43.5, 44, 44.5, 45, 45.5, 46, 46.5, 47, 47.5, 48, 48.5, 49, 49.5, 50, 50.5, 51, 51.5, 52, 52.5, 53, 53.5, 54, 54.5, 55, 55.5, 56, 56.5, 57, 57.5, 58, 58.5, 59, 59.5, 60, 60.5, 61, 61.5, 62, 62.5, 63, 63.5, 64, 64.5, 65, 65.5, 66, 66.5, 67, 67.5, 68, 68.5, 69, 69.5, 70, 70.5, 71, 71.5, 72, 72.5, 73, 73.5, 74, 74.5, 75, 75.5, 76, 76.5, 77, 77.5, 78, 78.5, 79, 79.5, 80, 80.5, 81, 81.5, 82, 82.5, 83, 83.5, 84, 84.5, 85, 85.5, 86, 86.5, 87, 87.5, 88, 88.5, 89, 89.5, 90, 90.5, 91, 91.5, 92, 92.5, 93, 93.5, 94, 94.5, 95, 95.5, 96, 96.5, 97, 97.5, 98, 98.5, 99, and 99.5 g/l. However, the catalyst is used preferably in the form of a moulding such as a granulate, extrudate or beads.

The water is brought into contact with a source of hydrogen peroxide and/or ozone in the presence of the catalyst according to the invention to break down the pollutants. The duration of the treatment (i.e., contact with hydrogen peroxide and/or ozone in the presence of catalyst) depends on the quantity and type of pollutants in the water. A person skilled in the art can carry out orientation tests to determine the optimum concentration of the oxidizing agent for his purposes and the duration of the treatment in view of this disclosure, which is normally in the range of a few minutes to several hours.

The process according to the invention can be performed using a continuous or batch method in a conventional suspension reactor which contains measures for the separation of the catalyst from the water. For example, the catalyst can be deposited in a sedimenter once the reaction is complete or may be separated from the treated water by means of a solid/liquid separation device. If a suspended catalyst is used in the form of particles that are easy to handle, simple sedimentation processes can be used for separation. If a fine powder catalyst is used, it must be separated off by a conventional filtration process.

In an embodiment preferred by the present invention, a suspension reactor such as a continuous-flow or batch-charged bubble column reactor can be combined with crossflow filtration when using a catalyst in powder form. In crossflow filtration, the suspension flows past a porous surface, in particular a surface in the form of a membrane and establishes a pressure difference between the overflow and permeate sides. This result in part of the solution flowing through the porous surface/membrane across the direction of flow of the suspension. Crossflow filtration is known. For examples, refer to the general article by S. Ripperger in Chem.-Ing.-Tech. 60 (1988) pages 155 to 161.

In an embodiment preferred by the present invention, the polluted water is treated using a moulded catalyst in a fixed bed reactor. The source of hydrogen peroxide is added at one or more points in front of and/or inside the reactor to the water to be treated while the water flows continuously through the catalyst bed. The fixed bed reactor can be operated both in its flooded state, as a bubble reactor, or as a trickle bed reactor. Slight loss of catalyst as a result of abrasion and/or by elution of the iron compound, which is carried out of the bed with the treated water can be tolerated because these compounds are widely used in effluent technology.

If the water is treated in a fixed bed reactor using ozone as the oxidizing agent, the latter can be fed in with or against the direction of flow as that of water to be treated.

If the water is treated using ozone in a bubble column reactor, in which the catalyst is suspended in the form of a fluidized bed, the reactor can be fumigated with ozone. As already stated, it is also possible to add a source of hydrogen peroxide to the water to be treated and also to fumigate with ozone as an oxidizing agent.

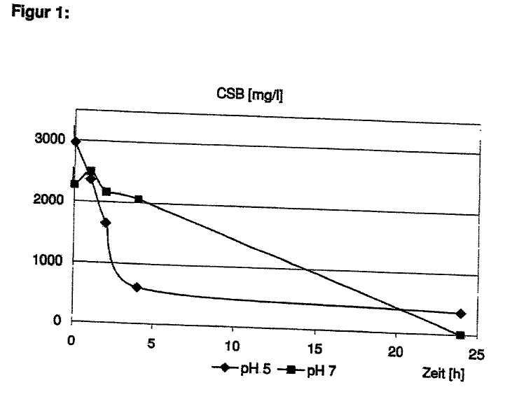

The process according to the invention is explained in more detail in FIGS. 1 to 3 and in the following examples.

### DETAILED DESCRIPTION OF THE DRAWINGS

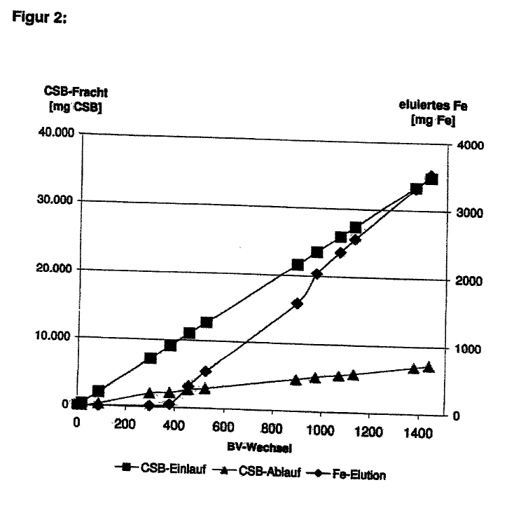

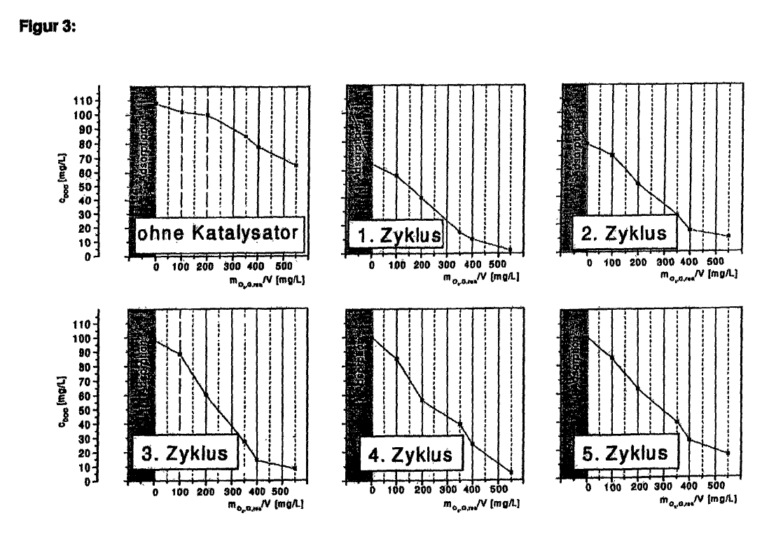

FIG. 1 shows a diagram of the treatment of water containing 2-chlorophenol according to the invention in the presence of granulated iron hydroxide. In the examples shown in FIG. 1 and also in FIGS. 2 and 3, a slightly crystallized beta-Fe(O)OH containing an Fe(OH)3 is used. Both curves in FIG. 1 show that COD degradation is faster at pH 5 than at pH7. However, a lower final value is achieved when performed at pH 7.

FIG. 2 shows the oxidation of water containing 3-chlorobenzoate using a fixed bed reactor, filled with granulated iron hydroxide, the fixed bed being trickled with the water to be treated, to which hydrogen peroxide is added in advance. The curves show that even after a 1400-fold exchange of bed volume the degree of COD degradation remains substantially constant. FIG. 2 also shows Fe elution. While hardly any iron is eluted at first, a substantially constant elution of Fe, in proportion to the COD load introduced, subsequently resulted.

FIG. 3 shows the oxidation of water containing 3-chlorobenzoate with ozone and hydrogen peroxide as oxidizing agents and granulated iron hydroxide as the catalyst. The degree of degradation was consistently over 80%.

The process according to the invention has a number of advantages over other heterogeneously catalyzed oxidative processes and over the oxidation by Fenton's reagent. The process is simple to perform. It generally requires no technically costly apparatus. It produces a high degree of degradation, i.e. 60-90% COD degradation can easily be achieved. The ranges for the COD degradation that can be achieved include all specific values and subranges therebetween, such as 61, 62, 63, 64, 65, 66, 67, 68, 69, 70, 71, 72, 73, 74, 75, 76, 77, 78, 79, 80, 81, 82, 83, 84, 85, 86, 87, 88, and 89%. It requires no acidification of the water to be treated and thus also no neutralization stage. Therefore, there is no additional salinization required. Separation of the catalyst, where necessary, can be performed easily. The treatment can be carried out in fixed or fluidized bed reactor under mild temperature and pH conditions. Subsequent precipitation of any eluted iron is generally unnecessary. The catalyst is very effective and easy to obtain, and has a long residence time.

### EXAMPLES

The present invention is explained in more detail with the aid of the following embodiment examples. As can be seen from the following examples, the process according to the present invention is simple and cost-efficient, and results in a high degree of degradation without acidification at mild temperature and pH conditions.

### Example 1

2.5 L of a model effluent containing 1050 mg/l 2-chlorophenol (equivalent to a COD of 2500 mg/l) were added to a thermostatic suspension reactor and heated to a starting temperature (see below, 30° C. or 60° C.). 2 g/l of a granulated iron(III)hydroxide containing approximately equal quantities of Fe(OH)₃ and Fe(O)OH and 50 wt. % free moisture (GEH, Osnabrüick) and hydrogen peroxide at a stoichiometry of 1.6 in relation to the initial COD value, were then added. The pH value of the model effluent was set to pH 5 or pH 7. The model effluent was not buffered. The residual COD was analysed after various reaction times.

At pH 7, virtually complete oxidation of the COD after 24 hours was observed. At pH 5, 70-80% of the COD had already been oxidized within the first 4 hours. During these 4 hours, approximately 10% iron was released.

The results of Example 1 are represented in FIG. 1.

### Example 2

A glass column was filled with approximately 80 g of granulated iron hydroxide according to example 1 (bed volume approx. 76 cm³) and continuously trickled from above, at room temperature, with a model effluent containing approximately 100 mg/l 3-chlorobenzoate (equivalent to a COD of 320 mg/l). The pH value was not set, the model effluent had a pH of 6-7. Hydrogen peroxide was added in a concentration of approximately 1.0 g/l to the model effluent. Over a period of approximately 1400 bed volume changes, no break-through of the COD was observed. The degree of oxidation over this period was consistently approximately 80%. During treatment, there was only slight elution of iron, substantially in proportion to the quantity of effluent treated.

The results of Example 2 are represented in FIG. 2.

### Example 3

The combined use of ozone and hydrogen peroxide in the presence of a moulded iron(III)hydroxide-iron(III)oxide hydrate catalyst was investigated. For this purpose, 400 mL model effluent was placed in a bubble column with 3-chlorobenzoic acid in a quantity equivalent to a dissolved organic carbon (DOC) of 108 mg/l. 30 g/l catalyst was added and this was fumigated with air for 15 minutes. Then, the dissolved organic carbon (DOC) was determined. It was then ozonized for 15 minutes with 0.67 g O₃/minute. A 10% solution of hydrogen peroxide was then added to the reactor through a hose pump, in proportion to the ozone mass flow, at a rate of 0.2 g H₂O₂/minute. The DOC was determined at various times and plotted as a function of the quantity of ozone consumed up to this time. The solution was then poured off and a fresh 3-chlorobenzoate solution was again added to the catalyst recovered. This cycle was repeated four times.

The results of the 5 cycles according to the invention are shown in FIG. 3. For comparison, a test without the catalyst is shown in FIG. 3 as well. The addition of the catalyst significantly improved the degree of oxidation which could be achieved, which can be seen from the increase in elimination from approximately 40% to about 84-98%.

The present application claims priority to German Application No. DE 101 14 177.7, filed on Mar. 23, 2001, which is hereby incorporated by reference in it entirety.

Numerous modifications and variations on the present invention are possible in light of the above teachings. It is, therefore, to be understood that within the scope of the accompanying claims, the invention may be practiced otherwise than as specifically described herein.

Unless specifically defined, all technical and scientific terms used herein have the same meaning as commonly understood by a skilled artisan in biochemistry, chemistry, and materials science.

All methods and materials similar or equivalent to those described herein can be used in the practice or testing of the present invention, with suitable methods and materials being described herein. All publications, patent applications, patents, standards, and other references mentioned herein are incorporated by reference in their entirety. In case of conflict, the present specification, including definitions, will control. Further, the materials, methods, and examples are illustrative only and are not intended to be limiting.

What is claimed is:

1. A process for treating water, comprising contacting said water with a source of hydrogen peroxide, ozone, or mixtures thereof in the presence of a heterogeneous catalyst, wherein the catalyst comprises an Fe(III)—OH structural element.

2. The process according to claim 1, wherein the catalyst comprises Fe(O)OH.

3. The process according to claim 1, wherein the catalyst comprises 3—Fe(O)OH produced by neutralization precipitation from an Fe(III) salt with subsequent dehydration.

4. The process according to one of claim 1, wherein the catalyst is in the form of a moulding.

5. The process according to claim 1, wherein the catalyst is in granulated form.

6. The process according to claim 1, wherein said contacting is carried out at a pH of from 3 to 9.

7. The process according to claim 1, wherein said contacting is carried out at a pH of from 5 to 9.

8. The process according claim 1, wherein active oxygen in the form of H₂O₂, ozone, or mixtures thereof is present in said water at a quantity of from 0.1 to 25 g per g COD to be eliminated.

9. The process according to claim 1, wherein said contacting is carried out at a temperature of from 10 to 50° C.

10. The process according to claim 1, wherein said contacting comprises:
feeding said water over a fixed bed reactor filled with said catalyst by means of a bubble or trickle bed method; and
adding hydrogen peroxide or a source thereof continuously or periodically to untreated or partially treated water.

11. The process according to claim 1, wherein said contacting comprises:
feeding said water over a fixed bed reactor filled with said catalyst by means of a bubble or trickle bed method; and
fumigating said water, said reactor, or both with ozone.

12. The process according to claim 1, wherein said contacting comprises:
feeding said water over a fixed bed reactor filled with said catalyst by means of a bubble or trickle bed method;
adding hydrogen peroxide or a source thereof continuously or periodically to untreated or partially treated water; and
fumigating said water, said reactor, or both with ozone.

13. The process according to claim 1, wherein said catalyst is suspended.

14. The process according to claim 13, further comprising
separating said water from the suspended catalyst by means of a crossflow filtration device subsequent to said contacting.

15. The process according to claim 1, wherein said catalyst further comprises at least one binder.

16. The process according to claim 15, wherein said binder is one member selected from the group consisting of silica sol, precipitated silica, pyrogenic silica, aluminum oxide, and aluminum silicate.

17. The process according to claim 1, wherein the water comprises an oxidizable compound.

18. The process according to claim 17, wherein the oxidizable compound is at least one member selected from the group consisting of a sulfurous organic substance, carboxylic acid, amide, amine, aliphatic hydrocarbon, mononuclear aromatic compound, polynuclear aromatic compound, heteroaromatic compound, halogenated compound, homocyclic cycloaliphatic compound, and heterocyclic cycloaliphatic, water-soluble polymer, emulsified polymer, water-soluble copolymer, and emulsified copolymer.

19. The process according to claim 17, wherein the oxidizable compounds are present at a concentration of from 1 to 100 g COD per 1.

20. The process according to claim 1, wherein the water is effluent.
